(19) United States
(12) Patent Application Publication
(10) Pub. No.: US 2026/0257703 A1
(43) Pub. Date: Sep. 3, 2026

(54) RAILWAY BRAKING SYSTEM FOR A RAILWAY VEHICLE HAVING BRAKES WITH AT LEAST ONE SHOE, AND RAILWAY VEHICLE PROVIDED WITH SUCH A SYSTEM

(71) Applicant: WABTEC Hauts-de-France, Amiens (FR)

(72) Inventors: Claudino Goncalves, Ribeaucourt (FR); Louis Maillard, Rivery (FR); Guewen Blasi, Amiens (FR); Denis Gerber-Papin, l'Etoile (FR)

(73) Assignee: WABTEC Hauts-de-France, Amiens (FR)

(21) Appl. No.: 18/713,318

(22) PCT Filed: Nov. 23, 2022
(86) PCT No.: PCT/FR2022/052163

§ 371 Date: May 24, 2024

(30) Foreign Application Priority Data
Nov. 24, 2021 (FR) FR2112438

(51) Int. Cl. B61H 13/38; B61H 1/00; F16D 49/00; F16D 65/06

(52) U.S. Cl. CPC B61H 13/38; B61H 1/003; F16D 65/062; F16D 49/00; F16D 2200/0013; F16D 2200/0021; F16D 2200/003; F16D 2200/0034; F16D 2200/006

(57) ABSTRACT

The invention relates to a railway braking system comprising a body having first smooth holes opening onto an outer face of the body, a fastening interface having first tapped orifices opening onto a first face of the interface, and second tapped orifices opening onto a second face of the interface, first fastening members for mechanically securing the interface to the body; the first face of the interface is mounted so as to bear against the outer face of the body, the first smooth holes of the body being situated facing the first tapped orifices of the interface, and the first fastening members are introduced into the first smooth holes of the body and the first tapped orifices of the interface to mechanically secure them, thus leaving access free to the second tapped orifices for mechanically securing a support of a railway vehicle to the second face of the interface.

### TECHNICAL FIELD OF THE INVENTION

The invention relates to the field of braking railway vehicles. In particular, it relates to a railway braking system having brakes with at least one shoe configured to be mechanically connected to a support of a railway vehicle.

The invention also relates to a railway vehicle having brakes with at least one shoe, including such a braking system and a support to which the braking system is mechanically connected.

### STATE OF THE ART

Railway vehicles having brakes with at least one shoe, or at least one brake block, these two terms being used interchangeably in this specification, are generally equipped with braking systems having service and/or parking brake cylinders, including a piston being movable under the effect of a pressurised fluid, the movement of this piston actuating a shoe holder, or brake shoe holder, to which at least the shoe, or the brake shoe, is mechanically connected, and causing a braking action such as the clamping of the shoe, or of the brake block, to a vehicle wheel.

Such a braking system is mounted to the railway vehicle, to be in contact with one or more wheels. In particular, it can be mechanically connected to a bogie, or to an axle fastened to the bogie, or to another device of the drive motor or gearbox type also mounted to the bogie.

To do so, known braking systems are provided with a body forming the cylinder, which is made of steel and/or cast iron and in which a number of female threads are provided for fastening the support of the vehicle.

The use of steel and/or cast iron for the body results in a relatively high weight for the whole system.

### DISCLOSURE OF THE INVENTION

The invention relates to a railway braking system having brakes with at least one shoe configured to be mechanically connected to a support of a railway vehicle, which is simple, convenient and economical.

One object of the invention is thus, in a first aspect, a railway braking system having brakes with at least one shoe, configured to be mechanically connected to a support of a railway vehicle and including a body having one or more attachment points for the support, characterised in that the body is made of light alloy and/or composite and has one or more first smooth holes opening at least onto an outer face of the body, the railway braking system further includes a fastening interface made from steel and/or cast iron and having one or more first tapped orifices opening at least onto a first face of the fastening interface, and one or more second tapped orifices opening at least onto a second face of the fastening interface, opposite to the first face, and the railway braking system further includes one or more first fastening members for mechanical connecting the fastening interface to the body ; and the railway braking system is configured so that the first face of the fastening interface is mounted so as to bear against the outer face of the body, with the first smooth hole(s) of the body being situated facing the first tapped orifice(s) of the fastening interface and the first fastening member(s) being introduced into the first smooth hole(s) of the body and the first tapped orifice(s) of the fastening interface for mechanical connecting thereof, thus leaving access free to said one or more second tapped orifices for mechanical connecting the support of the vehicle to the second face of the fastening interface, via one or more second fastening members.

As the body is made of a light alloy and/or composite, the railway braking system thus has a reduced weight compared with a system where the body is made of steel and/or cast iron.

Moreover, this reduction in weight and the use of a light and/or composite alloy does not detract from the safety of fastening this system to the support of the vehicle by virtue of the presence of the fastening interface, or flange, which is in turn made of steel and/or cast iron.

In other words, the light alloy and/or composite body simply has one or more smooth holes, which are not subjected to a high tightening torque in a female thread. It is the fastening interface which has tapped orifices and which, on the one hand, is therefore subjected to a high tightening torque from the first fastening members for securing the body to this fastening interface and which, on the other hand, is configured to be subjected to a high tightening torque from the second fastening members for securing the support of the vehicle to this fastening interface, and therefore the system to the vehicle.

The use of the fastening interface is furthermore particularly convenient in that it is possible to modify the centre distances of the different holes and/or ports as required, and both as a function of the body of the system and of the support of the vehicle.

Preferred, simple, convenient and economical characteristics of the railway braking system according to the invention are set forth below.

The body can be made from aluminium and/or magnesium, and/or from carbon, carbon fibres or polymer.

At least one first smooth hole can open onto the outer face of a first side of the body and of a second side of the body opposite to its first side, and at least one first fastening member is mounted so as to pass through into an inner space of the body.

At least one first smooth hole can pass through the body and open onto the outer face of a first side of the body and of a second side of the body opposite to its first side, and at least one first fastening member is mounted so as to pass through into the body.

The body can include at least one third smooth hole opening into the outer face of the body, the fastening interface can include at least one fourth smooth hole opening into its first face and located facing the at least one third smooth hole, and the railway braking system can include a centring member introduced and mechanically connected into the at least one third smooth hole and the at least one fourth smooth hole.

The railway braking system can include a force take-up bushing made of steel and fitted into at least the at least one third smooth hole of the body.

The railway braking system can be provided with a shoe holder mechanically connected to at least one attachment arm formed as a single piece with the body projecting from its outer face, with one or more shoes mechanically connected to the shoe holder, with an actuating mechanism housed in the body and configured to act on the shoe holder at least when the railway braking system is in a braking configuration to brake the railway vehicle, and with at least one link mechanically connected at a first end to the attachment arm and at a second end, opposite to the first end, to the shoe holder.

The railway braking system can be provided with a pair of arms to which a pair of links is mechanically connected, each link being provided with a through fifth smooth hole at its second end, and the railway braking system includes a third fastening member mounted through the links and the shoe holder to mechanically connect the links and the shoe holder together.

Each link can include a cylindrical wall having a slotted edge, and the railway braking system can further be provided with an indexing member, for example a key, interposed between the cylindrical walls of the links and co-operating with the respective slotted edges.

The at least one link can be made of light alloy and/or composite and have a sixth smooth hole, the at least one arm of the body can be provided with a seventh smooth hole located facing the sixth smooth hole of the link, and the railway braking system can further be provided with a bushing housed at least partially in one of the sixth smooth hole of the link and the seventh smooth hole of the arm, and with a pin introduced into the bushing and fitted into the other of the sixth smooth hole of the link and the seventh smooth hole of the arm.

The at least one link can be made of steel and/or cast iron and have a third tapped orifice, the at least one arm of the body can be provided with a seventh smooth hole located facing the third tapped orifice of the link, and the railway braking system can further be provided with a bushing housed at least partially in the seventh smooth hole of the arm, and with a threaded pin introduced into the bushing and screwed into the third tapped orifice of the link.

In a second aspect, one object of the invention is also a railway vehicle having brakes with at least one shoe, including a braking system as described above and a support to which the braking system is mechanically connected.

The support can be made from steel and/or cast iron and provided with one or more through fourth tapped orifices which are located facing the second tapped orifice(s) on the second face of the fastening interface, and the railway vehicle includes one or more second fastening members mounted into the fourth tapped orifice(s) and the second tapped orifice(s) of the fastening interface so as to mechanically connect the support to the fastening interface.

The body of the railway braking system can include at least one third smooth hole opening into the outer face of the body, the fastening interface of the railway braking system can include at least one fourth smooth hole opening into its first face and into its second face and located facing the at least one third smooth hole, the support of the railway vehicle can include at least one through eighth smooth hole, and the railway braking system can include a centring member introduced and mechanically connected into the at least one third smooth hole of the body and the at least one fourth smooth hole of the fastening interface and the at least one eighth smooth hole of the support.

### BRIEF DESCRIPTION OF THE FIGURES

The disclosure of the invention will now be continued by describing exemplary embodiments, given below by way of indicating and not limiting purposes, with reference to the appended drawings.

FIG. 1 illustrates a perspective view of a railway braking system for a railway vehicle, having brakes with at least one shoe, mechanically connected to a support on the railway vehicle.

FIG. 2 is a view similar to FIG. 1, without the support of the railway vehicle.

FIG. 3 is a view similar to FIG. 2, but devoid of a front part especially including a shoe-device and force transmission links.

FIG. 4 is a view similar to FIG. 3, partially showing the braking system in side view.

FIG. 5 is a cross-section view marked V-V in FIG. 4, but with the support visible in FIG. 1.

FIG. 6 is a view similar to FIG. 3, taken along a different viewing angle.

FIG. 7 is a partial side view of the railway braking system in FIG. 1, and shows in particular the front part including especially the shoe-device and the force transmission links.

FIG. 8 is a partial cross-section view marked VIII-VIII in FIG. 7.

FIG. 9 is a partial cross-section view marked IX-IX in FIG. 8.

FIG. 10 illustrates an isolated, disassembled perspective view of the force transmission links of the front part visible in FIGS. 7 and 8.

FIG. 11 is a view similar to FIG. 8, showing an alternative embodiment of the front part of the railway braking system.

### DETAILED DESCRIPTION

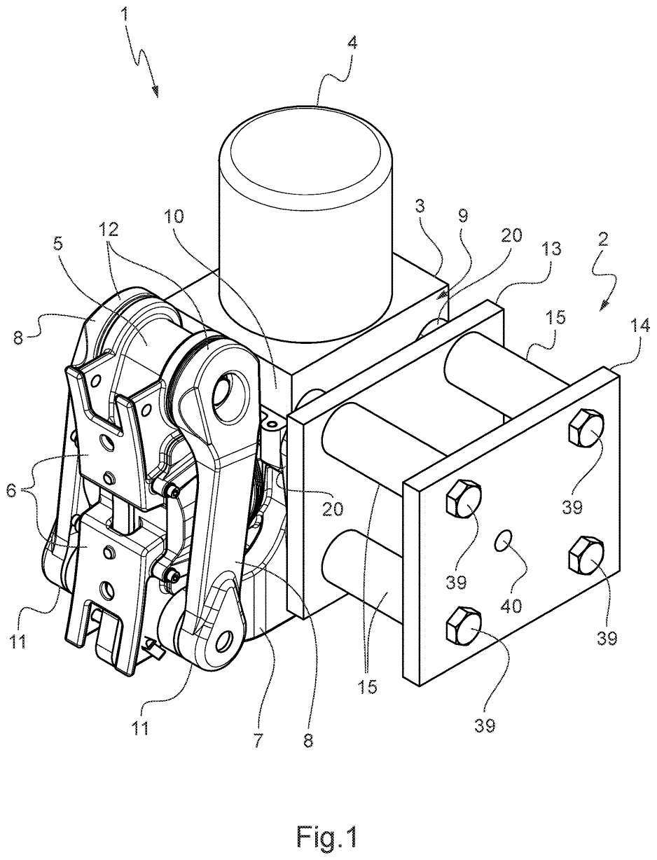

FIG. 1 illustrates a railway braking system 1 configured to be mounted to a railway vehicle with shoe-brakes, via a support 2 of this vehicle.

The railway braking system 1 includes a body 3 in which an actuating mechanism (not visible) is housed, an actuator 4 mounted projecting to the body 3 and configured to act on the actuating mechanism, and a shoe holder 5 to which one or more shoes 6, or brake blocks, are mechanically connected.

The actuator 4 can be pneumatic, hydraulic or electric.

The actuating mechanism, together with the actuator 4, can form a service brake and/or a parking brake for the railway vehicle.

The body 3 can in turn be compared to a service and/or parking brake cylinder.

The body 3 is made of a light alloy, for example from aluminium and/or magnesium.

Alternatively, the body can be made of a light alloy and a composite or only a composite, for example from carbon, carbon fibre, polymer, etc.

The actuating mechanism housed in the body 3, under the effect of the actuator 4, is configured to act on the shoe holder 5 at least when the railway braking system 1 is in a braking configuration to brake the railway vehicle.

In particular, the shoe holder 5 is moved so that the shoe(s) 6 come to bear against a wheel of the vehicle with a view to braking the latter.

The railway braking system 1 is here provided with two attachment arms 7 formed as a single piece with the body 3, projecting from an outer face 9 of the body 3.

The attachment arms 7 extend from a front wall 10 of the body 3.

The shoe holder 5 is mechanically connected to the attachment arms 7.

The railway braking system 1 further includes two links 8 configured to absorb and transmit braking-related forces from the shoe holder 5 to the rest of the railway braking system 1.

Each link 8 is mechanically connected by a first end 11 to a respective attachment arm 7 and by a second end 12, opposite to the first end 11, to the shoe holder 5.

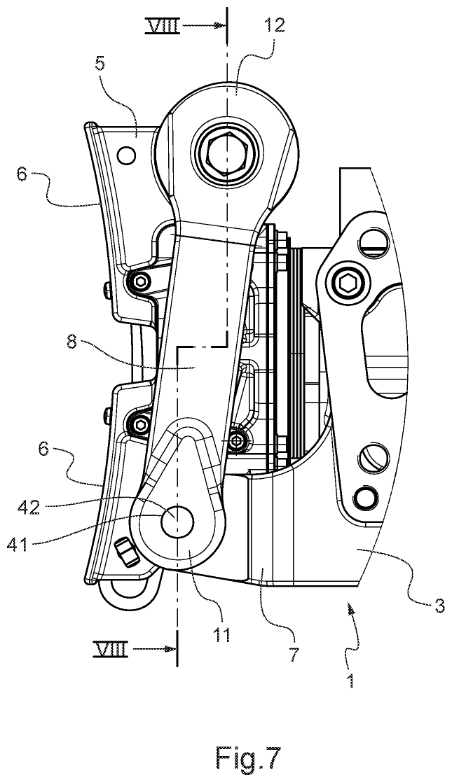

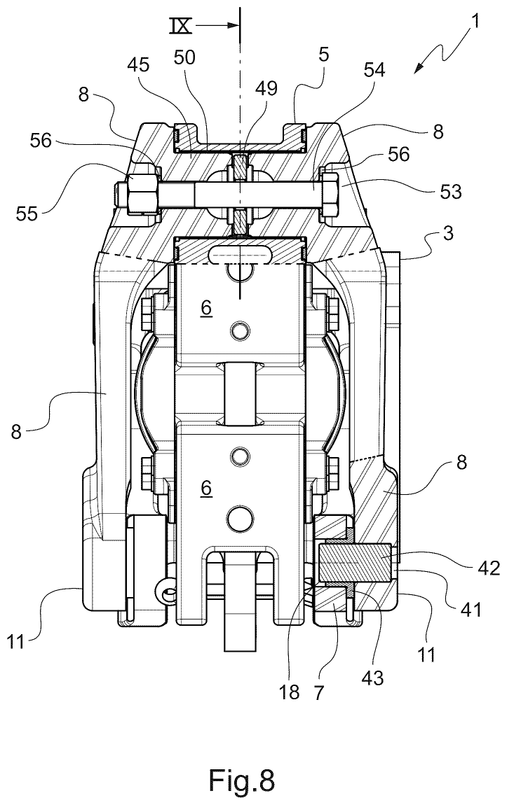

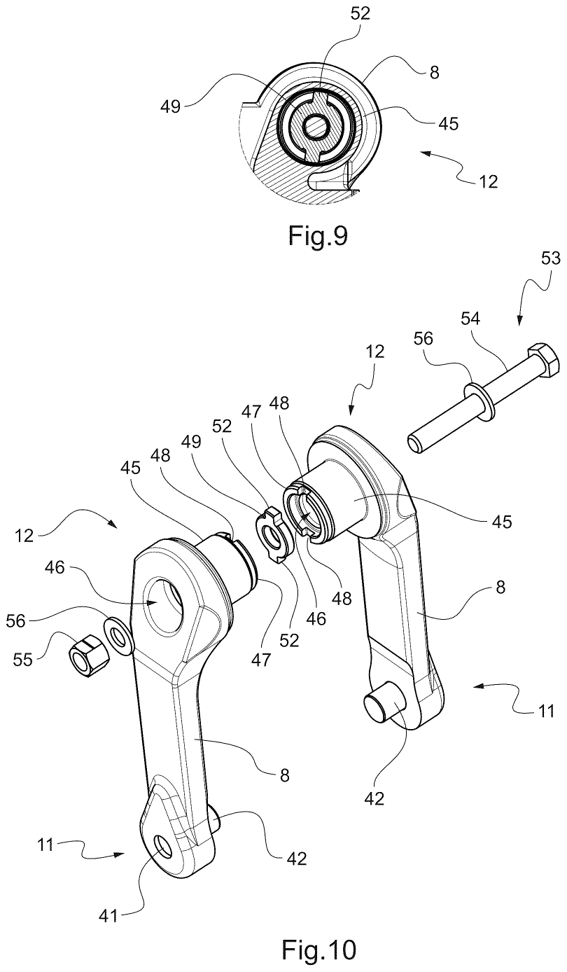

Details of how the links 8 are fastened to the arms 7 and to the shoe-holder 5 will be given below with reference to FIGS. 7 to 10 and 11.

The support 2 of the railway vehicle is made from steel and/or cast iron.

The support 2 here includes a first plate 13, a second plate 14 and reinforcing arms 15 interposed between the first plate 13 and the second plate 14.

The railway braking system 1 further includes a fastening interface 20 which is interposed between the body 3 and the support 2.

Like the support 2, the fastening interface 20 is made from steel and/or cast iron.

The support 2 is therefore mechanically connected to the body 3, by its first plate 13 and via the fastening interface 20.

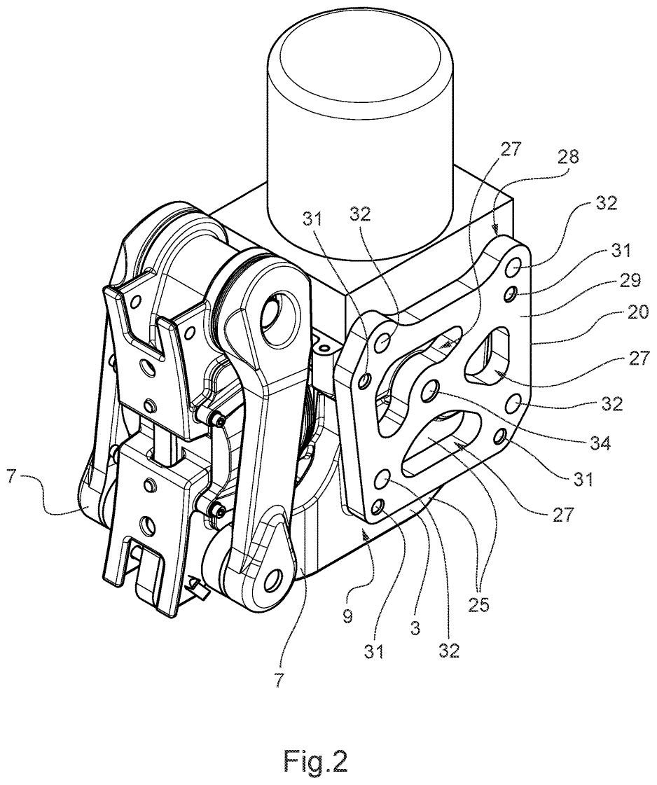

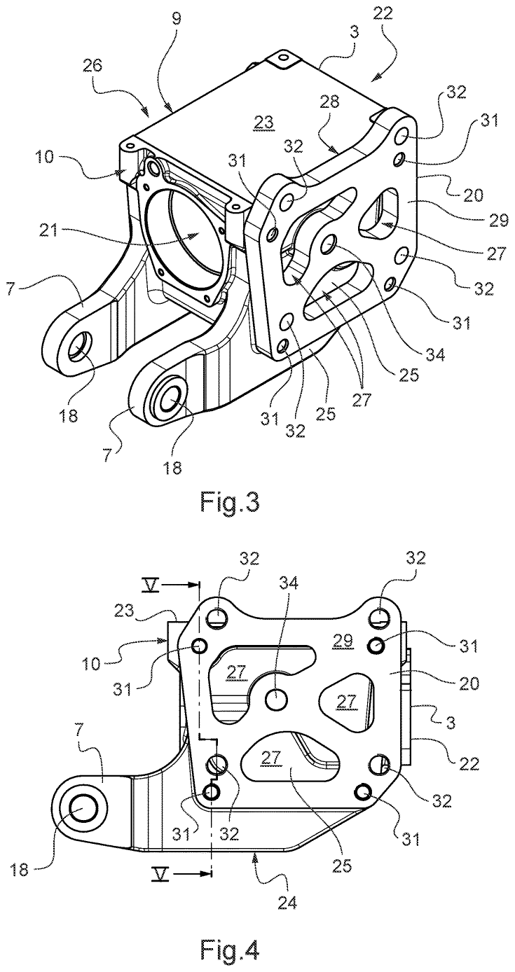

FIGS. 2 to 6 show in more detail the body 2 and the fastening interface 20 of the railway braking system 1.

The body 3 has an overall parallelepiped shape defining the outer face 9 and an inner space 21.

In particular, the body 3 is provided with the front wall 10 from which the attachment arms 7 project, with a rear wall 22 opposite to the front wall 21, with a top wall 23 joining the front and rear walls 10 and 22, with a bottom wall 24 opposite to the top wall 23 and joining the front and rear walls 10 and 22, with a first side wall 25 joining the front and rear walls 10 and 22 and the top and bottom walls 23 and 24, and with a second side wall 26 opposite to the first side wall 25 and joining the front and rear walls 10 and 22 and the top and bottom walls 23 and 24.

The attachment arms 7 are provided at their respective ends with an attachment zone formed here by the through seventh smooth hole 18.

In the example illustrated, the body 3 has several attachment points for the support 2 via the fastening interface 20.

The body 3 has several first smooth holes 30 opening onto the outer face 9 of the body 3 and in particular here onto each of the first and second side walls 25 and 26.

The first smooth holes 30 here extend throughout the body 3 between the first and second side walls 25 and 26.

The first smooth holes 30 are formed here basically at each corner of the body 3.

The body 3 here includes a third smooth hole 33 opening into the outer face 9 of the body 3, and in particular onto its first side wall 25.

In the example illustrated, the third smooth hole 33 is blind.

The railway braking system 1 includes a force take-up bushing 35 made of steel and fitted into the third smooth hole 33 in the body 3.

The fastening interface 20 has a first face 28 and a second face 29, opposite to the first face 28.

The fastening interface 20 is here in the form of an overall rectangular plate, in which recesses 27 are provided.

These recesses 27 are essentially formed to limit the material of the fastening interface 20, which is made from steel and/or cast iron.

These recesses 27 open onto its first and second faces 28 and 29.

The fastening interface 20 is provided with several first tapped orifices 31 opening here onto its first and second faces 28 and 29.

The fastening interface 20 is further provided with a plurality of second tapped orifices 32 also opening here onto its first and second faces 28 and 29.

The fastening interface 20 includes a fourth smooth hole 34 opening here onto its first and second faces 28 and 29.

The railway braking system 1 is configured so that the first face 28 of the fastening interface 20 is mounted so as to bear against the outer face 9 and in particular here the first side wall 25 of the body 3, with the first smooth holes 30 of the body 3 being situated facing the first tapped orifices 31 of the fastening interface 20. Furthermore, the third smooth hole 33 of the body 3 faces the fourth smooth hole 34 of the fastening interface 20.

It should be noted that the third and fourth smooth holes are all provided here substantially in the centre of the body and the fastening interface respectively.

The railway braking system 1 further includes several first fastening members 36 for mechanical connecting the fastening interface 20 to the body 3.

The first fastening members 36 are introduced into the first smooth holes 30 of the body 3 and are mechanically connected into the first tapped orifices 31 of the fastening interface 20 for mechanical connecting thereof.

The first fastening members 36 are mounted so as to pass through into the body 3 from the second side wall 36 to the first side wall 25.

The first fastening members 36 are here formed by screws which are screwed into the first tapped orifices 31 of the fastening interface 20.

The railway braking system 1 further includes a centring member 37 introduced and mechanically connected into the third smooth hole 33 of the body 3 which includes the force take-up bushing 35 and in the fourth smooth hole 34 of the fastening interface 20.

The assembly of the fastening interface 20 to the body 3 as described above allows access free to the second face 29 of this fastening interface 20 and in particular to its second tapped orifices 32, for mechanical connecting the support 2 of the vehicle to the second face 29 of the fastening interface 20.

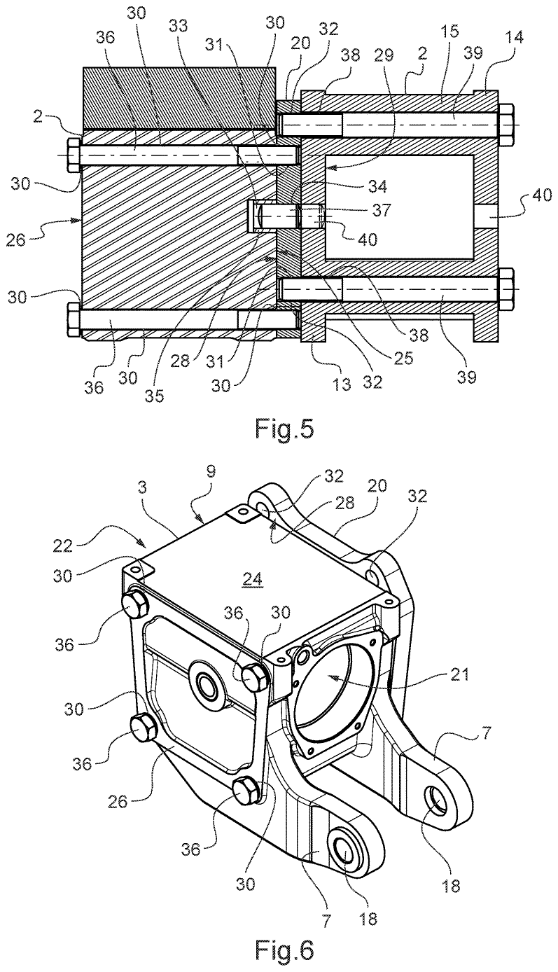

As visible in FIG. 5, the support 2 includes several through fourth tapped orifices 38 which are located facing the second tapped orifices 32 on the second face 29 of the fastening interface 20.

The railway vehicle includes several second fastening members 39 mounted into the fourth tapped orifices 38 of the support 2 and into the second tapped orifices 32 of the fastening interface 20 so as to mechanically connect the support 2 to the fastening interface 20 (see FIGS. 1 and 5).

The support 2 of the railway vehicle here also includes a through eighth smooth hole 40 provided in each of the first and second plates 13 and 14.

The through eighth smooth holes 40 are here located facing the fourth smooth hole 34 of the fastening interface 20 and can be used to centre the support 2 on the fastening interface 20.

At least one of the through eighth smooth holes 40 could also receive the centring member.

Because the body 3 is made of a light alloy, the railway braking system 1 has a reduced weight compared with a system where the body is made of steel and/or cast iron.

Moreover, this reduction in weight and the use of a light alloy does not detract from the safety of fastening this system 1 to the support 2 of the vehicle by virtue of the presence of the fastening interface 20, or flange, which is in turn made of steel and/or cast iron.

In other words, the light alloy body 3 simply has smooth holes 30, which are not subjected to a high tightening torque. It is the fastening interface 20 which has first and second tapped orifices 31 and 32 and which, on the one hand, is therefore subjected to a high tightening torque from the first fastening members 36 for mechanically connecting the body 3 to this fastening interface 20 and which, on the other hand, is configured to be subjected to a high tightening torque from the second fastening members 39 for mechanically connecting the support 2 of the vehicle to this fastening interface 20, and therefore the system 1 to the vehicle.

The use of the fastening interface 20 is furthermore particularly convenient in that it is possible to modify the centre distances of the different holes and/or ports as required, and both as a function of the body 3 of the system 1 and of the support 2 of the vehicle.

With reference to FIGS. 7 to 10 and 11, the mechanical connecting of the links 8 to the attachment arms 7 of the body 3 and to the shoe holder 5 carrying the shoe(s) 6 of the railway braking system 1 is now described.

In the example illustrated, the links 8 are made of light alloy, for example from aluminium and/or magnesium.

Each link 8 has a sixth smooth hole 41 formed at its first end 11 and located facing the seventh smooth hole 18 of a respective attachment arm 7 of the body 3.

The railway braking system 1 is provided with bushings 43 and pins 42 for mounting the links 8 to the attachment arms 7.

Each bushing 43 is here housed at least partially in the seventh smooth hole 18 of the respective attachment arm 7, and each pin 42 is introduced into a respective bushing 43 and fitted into the sixth smooth bore 41 of the respective link 8.

Each link 8 is further provided, at its second end 12, with a sleeve-forming cylindrical wall 46, which is configured to be introduced into a housing 50 formed in the shoe holder 5, and with a fifth smooth hole 46 passing through the cylindrical wall 46.

In the example illustrated, the cylindrical wall 46 of each link 8 has a slotted edge 47 at its respective free end, thus forming indexing notches 48.

The railway braking system 1 includes an indexing member 49 formed here by a key having indexing protrusions 52, and interposed between the cylindrical walls 46 of the links 8, with the indexing protrusions 52 being at least partially received in the indexing notches 48 for positioning the links 8 relative to each other and relative to the shoe holder 5.

The railway braking system 1 further includes a third fastening member 53 mounted through the fifth smooth holes 46 of the links 8 and therefore in the housing 50 of the shoe holder 5 to mechanically connect the links 8 and the shoe holder 5 together.

The third fastening member 53 is formed here by a system with screws 54, nuts 55 and washers 56.

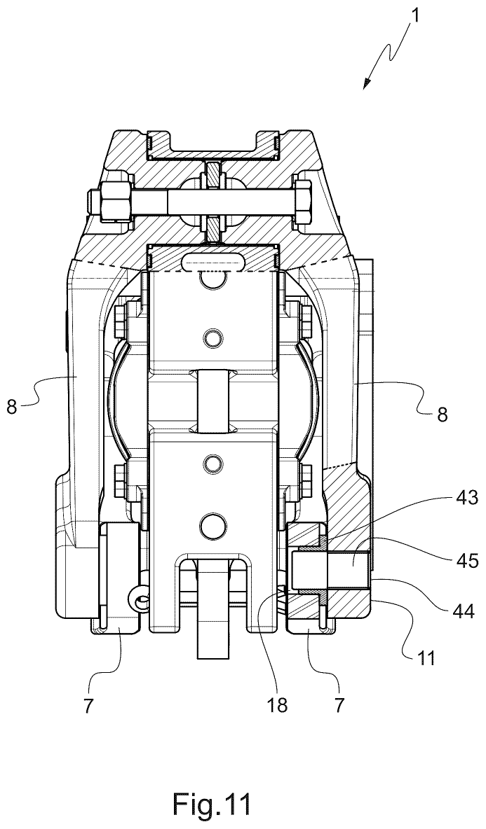

FIG. 11 differs from FIG. 10 only in the way the links 8 are mounted to the attachment arms 7.

In particular, the links 8 are instead made from steel and/or cast iron and each have a third tapped orifice 44 formed at their first end 11 and located facing the seventh smooth hole 18 of a respective attachment arm 7 of the body 3, and into which a threaded pin 45 is screwed, which threaded pin 45 is also introduced into the bushing 43 housed at least partially in the seventh smooth hole 18 of the respective attachment arm 7.

Alternatives not illustrated are described below.

There can be 2, 3 or more than 4 first smooth holes.

The first smooth holes can open into the inner space of the body and be present only on the first side wall.

The first fastening members can be mounted so as to pass through into the inner space of the body.

At least some of the first smooth holes can be formed at locations different from the corners of the body, for example more in the centre.

The fastening interface is provided with first tapped orifices opening only onto its first face.

The fastening interface is provided with second tapped orifices opening only onto its second face.

The force take-up bushing could be housed in the fourth smooth hole in the fastening interface.

The system could be devoid of the centring member, the force take-up bushing and the associated smooth holes.

The third and fourth smooth holes are provided elsewhere than in the centre of the body and the fastening interface respectively.

The system can be devoid of a mechanism for indexing the links or can include a mechanism different from that described above.

More generally, the invention is not limited to the examples described and represented.

1. A railway braking system having brakes with at least one shoe, configured to be mechanically connected to a support (2) of a railway vehicle and including a body (3) having one or more attachment points for the support, wherein the body is made of light alloy and/or composite and has one or more first smooth holes (30) opening at least onto an outer face (9) of the body, the railway braking system (1) further including a fastening interface (20) made from steel and/or cast iron and having one or more first tapped orifices (31) opening at least onto a first face (28) of the fastening interface, and one or more second tapped orifices (32) opening at least onto a second face (29) of the fastening interface, opposite to the first face, and the railway braking system further including one or more first fastening members (36) for mechanical connecting the fastening interface to the body; and the railway braking system is configured so that the first face (28) of the fastening interface is mounted so as to bear against the outer face (9) of the body, with the one or more first smooth holes (30) of the body being situated facing the one or more first tapped orifices (31) of the fastening interface and the one or more first fastening members (36) being introduced into the one or more first smooth holes (30) of the body and the one or more first tapped orifices (31) of the fastening interface for mechanical connecting thereof, thus leaving access free to said one or more second tapped orifices (32) for mechanical connecting the support (2) of the railway vehicle to the second face of the fastening interface, via one or more second fastening members (39).

2. The railway braking system of claim 1, wherein the body (3) is made from at least one of aluminium, magnesium, carbon, carbon fibres, or polymer, or any combination thereof.

3. The railway braking system one of claim 1, wherein at least one of the one or more first smooth holes (30) opens onto the outer face (9) of a first side of the body (3) and of a second side of the body opposite to the first side, and at least one first fastening member (36) is mounted so as to pass through into an inner space (21) of the body.

4. The railway braking system of claim 1, wherein at least one of the one or more first smooth holes passes through the body and opens onto the outer face of a first side of the body and of a second side of the body opposite to the first side, and at least one of the one or more first fastening members is mounted so as to pass through into the body.

5. The railway braking system of claim 1, wherein the body (3) includes at least one third smooth hole (33) opening into the outer face (9) of the body, the fastening interface (20) includes at least one fourth smooth hole (34) opening into the first face (28) and located facing the at least one third smooth hole, and the railway braking system (1) includes a centring member (37) introduced into and mechanically connected into the at least one third smooth hole and the at least one fourth smooth hole.

6. The railway braking system of claim 5, further comprising a force take-up bushing (35) made of steel and fitted at least into the at least one third smooth hole (33) of the body (3).

7. The railway braking system of claim 1, further comprising a shoe holder (5) mechanically connected to at least one attachment arm (7) formed as a single piece with the body (3) projecting from the outer face (9), with one or more shoes (6) mechanically connected to the shoe holder, with an actuating mechanism housed in the body and configured to act on the shoe holder at least when the railway braking system (1) is in a braking configuration to brake the railway vehicle, and with at least one link (8) mechanically connected at a first end (11) to the at least one attachment arm and at a second end (12), opposite to the first end, to the shoe holder.

8. The railway braking system according to claim 7, c further comprising a pair of arms (7) to which a pair of links (8) is mechanically connected, each link being provided with a through fifth smooth hole (46) at the second end (12), and the railway braking system (1) including a third fastening member (53) mounted through the links and the shoe holder to mechanically connect the links and the shoe holder together.

9. The railway braking system according to claim 8, wherein each link (8) includes a cylindrical wall (45) having a slotted edge (47), and the railway braking system (1) is further provided with an indexing member (49) interposed between the cylindrical walls of the links and cooperating with the respective slotted edges.

10. The railway braking system of claim 7, wherein the at least one link (8) is made of light alloy and/or composite and has a sixth smooth hole (41), wherein the at least one attachment arm (7) of the body (3) is provided with a seventh smooth hole (18) located facing the sixth smooth hole of the at least one link, and the railway braking system (1) is further provided with a bushing (43) housed at least partially in the sixth smooth hole of the at least one link and the seventh smooth hole of the at least one attachment arm, and with a pin (42) introduced into the bushing and fitted into the other of the sixth smooth hole of the link and the seventh smooth hole of the arm.

11. The railway braking system of claim 7, wherein the at least one link (8) is made of steel and/or cast iron and has a third tapped orifice (44), wherein the at least one attachment arm (7) of the body (3) is provided with a seventh smooth hole (18) located facing the third tapped orifice of the at least one link, and the railway braking system (1) is further provided with a bushing (43) housed at least partially in the seventh smooth hole of the at least one attachment arm, and with a threaded pin (45) introduced into the bushing and screwed into the third tapped orifice of the link.

12. A railway vehicle having brakes with at least one shoe, including a braking system (1) according to claim 1 and a support (2) to which the braking system is mechanically connected.

13. The railway vehicle according to claim 12, wherein the support (2) is made from steel and/or cast iron and is provided with one or more through fourth tapped orifices (38) which are located facing the one or more second tapped orifices (32) on the second face (29) of the fastening interface (20), and the railway vehicle includes one or more second fastening members (39) mounted into the one or more through fourth tapped orifices and into the one or more second tapped orifices of the fastening interface so as to mechanically connect the support to the fastening interface.

14. The railway vehicle according to claim 12, wherein the body (3) of the railway braking system (1) includes at least one third smooth hole (33) opening into the outer face (9) of the body, the fastening interface (20) of the railway braking system includes at least one fourth smooth hole (34) opening into the first face (28) and into the second face (29) and located facing the at least one third smooth hole, the support (2) of the railway vehicle includes at least one through eighth smooth hole (40), and the railway braking system includes a centring member (37) introduced and mechanically connected into the at least one third smooth hole of the body and at least one fourth smooth hole of the fastening interface and at least one eighth smooth hole of the support.

15. The railway braking system of claim 9, wherein the indexing member is a key.
